(19) United States
(12) Patent Application Publication
(10) Pub. No.: US 2015/0357900 A1
(43) Pub. Date: Dec. 10, 2015

(54) Transitioning from Normal Mode to Low-Power Retention Mode

(71) Applicant: QUALCOMM Incorporated, San Diego, CA (US)

(72) Inventor: Michael Arn Nix, Austin, TX (US)

(21) Appl. No.: 14/298,390

(22) Filed: Jun. 6, 2014

(51) Int. Cl. H02M 1/08

(52) U.S. Cl. CPC H02M 1/08; H02M 2001/0032

(57) ABSTRACT

A retention mode manager circuit, including: a resistor and a capacitor configured as an RC filter, and the RC filter is configured to receive a retention voltage and output a filtered retention voltage; a retention amplifier configured to receive the filtered retention voltage at a first input terminal and to provide current to a load corresponding to the filtered retention voltage; and a transition amplifier configured to receive the filtered retention voltage and an offset voltage, and to guide the filtered retention voltage to make a transition to the offset voltage while minimizing undershoot or overshoot to prevent a loss of data in the load.

### BACKGROUND

1. Field

This invention relates to a retention mode operation, and more specifically, to smoothly transitioning from a normal mode to a low-power retention mode.

2. Background

With increased emphasis on low-power operation, many functional blocks of a system-on-a-chip (SoC) are put into a static state to lower the power consumption of the blocks. Once in the static state, the power supply voltage for a block can be lowered by a significant amount without losing any information. At this low-voltage static state, the block draws significantly less current from the power supply. However, the large power supplies that supply the current to the blocks of an SOC are very inefficient when supplying small amounts of current to a load. Thus, to maximize the power saving, it is desirable to turn off the large main regulator and use a low-power retention regulator to supply the current during this retention mode. A typical large regulator may consume 5 mA of current when supplying no power to the load it drives. A low-power retention regulator can typically use less than 10 μA of current while maintaining the voltage to the static block at its desired value.

### SUMMARY

The present invention provides for smoothly transitioning a supply voltage from a nominal value to a retention value.

In one embodiment, a retention mode manager circuit is disclosed. The retention mode manager circuit includes: a resistor and a capacitor configured as an RC filter, and the RC filter is configured to receive a retention voltage and output a filtered retention voltage; a retention amplifier configured to receive the filtered retention voltage at a first input terminal and to provide current to a load corresponding to the filtered retention voltage; and a transition amplifier configured to receive the filtered retention voltage and an offset voltage, and to guide the filtered retention voltage to make a transition to the offset voltage while minimizing undershoot or overshoot to prevent a loss of data in the load.

In another embodiment, a method for transitioning a supply voltage from a nominal value to a retention value is disclosed. The method includes: receiving a command from a controller to enter a retention mode; programming a load by the controller to be in a static state that allows retention of data consistency in the load; turning on a transition amplifier by the controller and waiting for the transition amplifier to stabilize; turning off a normal mode regulator by the controller; transitioning a retention mode regulator from a standby mode to the retention mode by the controller, and waiting for the supply voltage to transition from the nominal value to the retention value; and turning the transition amplifier off by the controller.

In another embodiment, an apparatus for transitioning a supply voltage from a nominal value to a retention value is disclosed. The apparatus includes: means for receiving and filtering a retention voltage and outputting a filtered retention voltage; means for receiving the filtered retention voltage and providing current to a load corresponding to the filtered retention voltage; and means for receiving the filtered retention voltage and an offset voltage and guiding the filtered retention voltage to make a smooth transition to the offset voltage without any undershoot or overshoot to prevent a loss of data in the load.

Other features and advantages of the present invention should be apparent from the present description which illustrates, by way of example, aspects of the invention.

### BRIEF DESCRIPTION OF THE DRAWINGS

The details of the present invention, both as to its structure and operation, may be gleaned in part by study of the appended further drawings, in which like reference numerals refer to like parts, and in which:

FIG. 1A is a functional block diagram of an SoC block including additional units such as a retention mode rail and retention mode managers configured to provide a smooth transition from the nominal voltage to the retention voltage in accordance with one embodiment of the present invention;

FIG. 1B is a functional block diagram of an SoC block in accordance with another embodiment of the present invention;

FIG. 2 is a functional block diagram of a retention mode manager similar to those shown in FIG. 1 in accordance with one embodiment of the present invention;

FIG. 3 is a flow diagram of the transition from the normal mode to the retention mode; and

FIG. 4 is an example timing diagram illustrating a transition process described above with respect to the flow diagram of FIG. 3 in accordance with one embodiment of the present invention.

### DETAILED DESCRIPTION

As stated above, to maximize the power saving, it is desirable to turn off the large main regulator and use a low-power retention regulator to supply the current during the retention mode. Embodiments as described herein provide for transitioning a supply voltage from a nominal value to a retention value. After reading this description it will become apparent how to implement the invention in various implementations and applications. Although various implementations of the present invention will be described herein, it is understood that these implementations are presented by way of example only, and not limitation. As such, this detailed description of various implementations should not be construed to limit the scope or breadth of the present invention.

The power supply voltage of a system-on-a-chip (SoC) block in a static state can be set as low as possible to maximize the power saving. However, if the voltage level drops too low, then the loss of data may occur. Thus, care must be taken in placing the SoC block into a low-power retention mode by smoothly transitioning the operational supply voltage from the nominal voltage to the retention voltage and turning off the large main regulator (i.e., the main/normal-mode regulator is large compared to the size of the low-power retention regulator). Further, the transition into the retention mode often results in an unacceptable undershoot of the supply voltage. Accordingly, the power supply voltage should not be allowed to undershoot the target value of the retention voltage during the transition. Modifications to the large main regulator can be made to configure the regulator better suited for the retention mode operation, but the modifications may not be practical because they may compromise the performance of the large main regulator for the normal-mode operation.

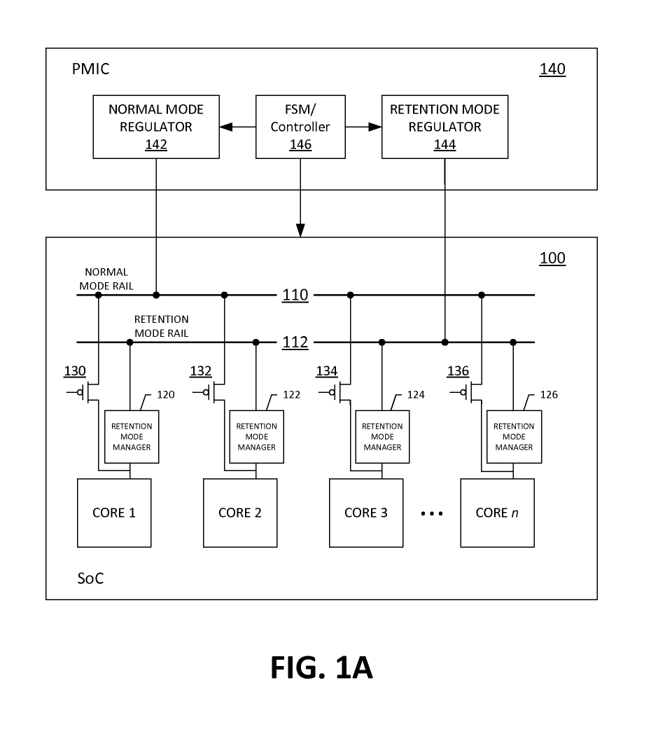

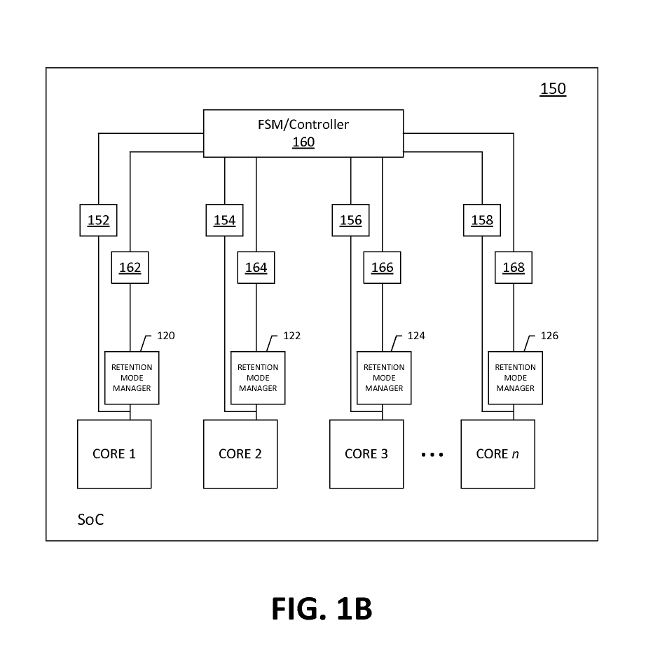

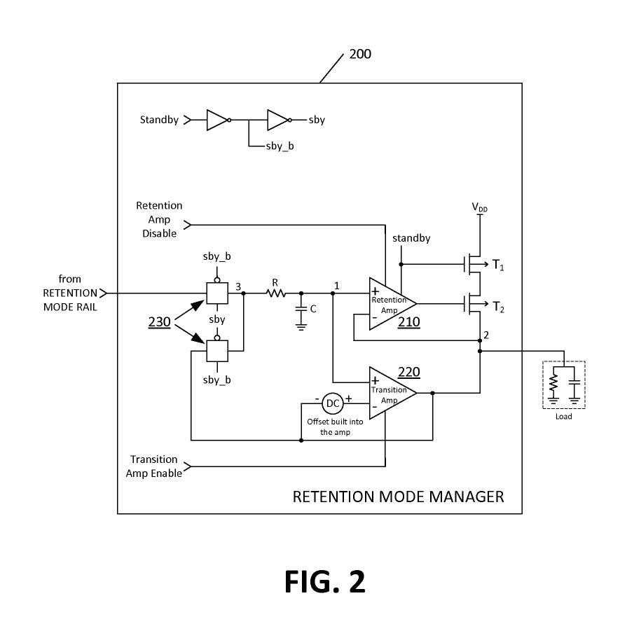

FIG. 1A is a functional block diagram of an SoC block 100 including additional units such as a retention mode rail 112 and retention mode managers 120, 122, 124, 126 configured to provide a smooth transition from the nominal voltage (on the normal mode rail 110) to the retention voltage (on the retention mode rail 112) in accordance with one embodiment of the present invention. In the illustrated embodiment of FIG. 1A, a power management integrated circuit (PMIC) 140 provides the nominal voltage from the normal mode regulator 142 (i.e., the main regulator) to the normal mode rail 110 in the SoC 100 and the retention voltage from the retention mode regulator 144 to the retention mode rail 112 in the SoC 100. One retention mode manager (see FIG. 2 for detail) 120, 122, 124, 126 is configured for each load (e.g., Core 1, Core 2, Core 3, . . . , Core n) to provide a smooth transition from the nominal voltage to the retention voltage separately for each core. The finite state machine (FSM)/controller 146 controls the normal mode regulator 142, the retention mode regulator 144, and the SoC 100. The FSM/controller 146 also turns on or off FET switches 130, 132, 134, 136 to supply the nominal voltage appearing on the normal mode rail 110 to the retention mode managers 120, 122, 124, 126. The FET switches 130, 132, 134, 136 supply the nominal voltage to the cores.

FIG. 1B is a functional block diagram of an SoC block 150 in accordance with another embodiment of the present invention. In the illustrated embodiment of FIG. 1B, each load (i.e., core) has an associated normal mode regulator 152, 154, 156, or 158, retention mode regulator 162, 164, 166, or 168, and retention mode manager 120, 122, 124, or 126. The FSM/controller 160 controls the normal mode regulators 152, 154, 156, 158 and the retention mode regulators 162, 164, 166, 168 by turning the regulators on or off

FIG. 2 is a functional block diagram of a retention mode manager 200 similar to the retention mode managers 120, 122, 124, 126 shown in FIG. 1A/1B in accordance with one embodiment of the present invention. In the illustrated embodiment of FIG. 2, the retention mode manager 200 includes a retention amplifier 210, a transition amplifier 220, a resistor (R), a capacitor (C), and a pair of transistors (T₁ and T₂). T2 is the main output device for controlling the retention voltage after the transition is made from normal-mode to retention-mode. T1 is added to prevent any contention between the normal-mode regulator and the retention-mode regulator before the normal-mode regulator is turned off. In an alternative embodiment, T1 is not included because retention-mode regulator may not be strong enough to affect the operation of the normal-mode regulator when they are both on. The deletion of T1 may also allow a better initial transition on the supply voltage because the retention amplifier is always in a closed-loop condition. With T1 in place, the retention amplifier is in an open-loop mode until standby goes low, but it takes a while for the retention amplifier to recover after the transition on standby. The resistor and the capacitor forms an RC filter, which receives a retention voltage at node 3 and outputs a filtered retention voltage at node 1. As shown in FIG. 2, node 3 is driven from a 2:1 analog multiplexer 230. During normal mode, the output of the multiplexer 230 comes from node 2. When standby goes low, the output of the multiplexer 230 comes from the retention mode rail.

In one embodiment, the retention amplifier 210 is configured as an operational transconductance amplifier (OTA) which is a voltage-controlled current source with an infinite input and output impedance. In particular, the retention amplifier 210 receives the filtered retention voltage at the first input terminal (node 1) and adjusts its output which drives the gate terminal of transistor T₂ to bring the voltage at the second input terminal (node 2) equal to the voltage at the first input terminal of the retention amplifier 210. Thus, transistor T₂ supplies current to the load (at node 2) corresponding to the voltage level of the filtered retention voltage (at node 1 which is same as the first input terminal of the retention amplifier 210). Transistor T₁ prevents transistor T₂ from supplying current to the load when the standby signal is high.

In one embodiment, the transition amplifier 220 is configured as a class-B amplifier with a built-in offset voltage and has no current flowing through the transistors of the class-B transition amplifier 220 when it is in a quiescent state. With a small built-in offset voltage added to the transition amplifier 220, the amplifier 220 drives the retention-voltage to a value slightly lower than the voltage that the retention amplifier 210 is trying to achieve. This is done so that when the transition amplifier 220 is turned off, the resulting disturbance on the retention voltage will be positive. A negative disturbance or undershoot is undesirable. The transition amplifier 220 receives the filtered retention voltage at the first input terminal and the offset voltage at the second input terminal, and guides the filtered retention voltage to make a smooth transition while minimizing undershoot or overshoot in the filtered retention voltage to prevent loss of data in the load. Thus, the transition amplifier 220 is responsible for the transition of the power supply voltage from the nominal value to the retention value. The transition amplifier 220 operates in regions where the output at node 2 does not cause signal collisions with the output signal of the retention amplifier 210.

The transition amplifier 220 is turned off after the completion of the transition. The power and bandwidth of the transition amplifier 220 is significantly greater than that of the retention amplifier 210, but is much less than the main/normal-mode regulator. When the system is switched from the normal mode to the retention mode, an RC filter (configured with resistor R and capacitor C) is used to control the smooth transition of the supply voltage from the nominal value to the retention value. The transition amplifier 220 has enough bandwidth to accurately follow the filtered reference voltage at node 1 while minimizing undershoot. Signals (e.g., Standby, Retention Amp Disable, and Transition Amp Enable) from the FSM/controller 146 control the retention amplifier 210 and the transition amplifier 220.

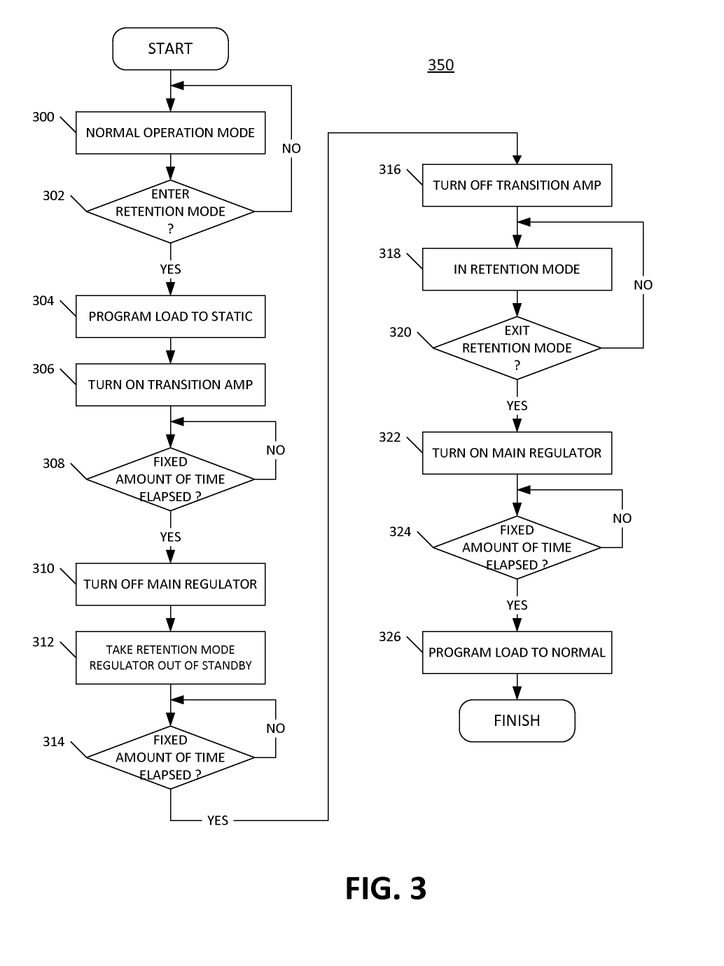

FIG. 3 is a flow diagram 350 of the transition from the normal mode to the retention mode. In the illustrated embodiment of FIG. 3, the system is powered up in a normal operation mode, at step 300. The normal mode regulator 142 is supplying the current to the load (e.g., Core 1, Core 2, Core 3, . . . , Core n) and the retention mode regulator 144 is turned on and is in a standby mode. When a command to enter the retention mode is received, at step 302, the load is programmed (e.g., by the FSM/controller 146) to be in a static state, at step 304. Further, the transition amplifier 220 is turned on, at step 306 (e.g., by the FSM/controller 146). After waiting for a fixed amount of time, at step 308, for the transition amplifier 220 to stabilize, the normal mode regulator 142 is turned off, at step 310 (e.g., by the FSM/controller 146). The retention mode regulator 144 is taken out of the standby mode, at step 312. The system waits for a fixed amount of time, at step 314, for the supply voltage to make the transition from the nominal value to the retention value. A smooth transition (without any large undershoot or overshoot) is controlled by the transition amplifier 220 which follows the output of the RC filter at node 1 (see FIG. 2). The transition amplifier 220 is then turned off, at step 316. This keeps the system in the retention mode for an indeterminate amount of time until a command to exit the retention mode is received, at step 320. The normal mode regulator 142 is turned on again, at step 322. After waiting for a fixed amount of time for the normal mode regulator 142 to stabilize, at step 324, the system enters the normal mode. Further, the load is programmed (e.g., by the FSM/controller 146) from the static retention mode back to the normal mode, at step 326.

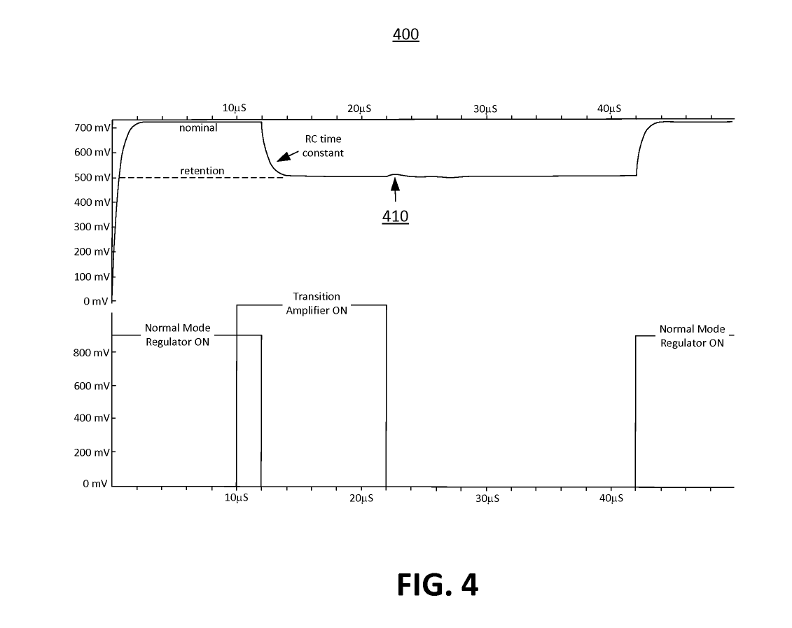

FIG. 4 is an example timing diagram illustrating a transition process 400 described above with respect to the flow diagram of FIG. 3 in accordance with one embodiment of the present invention. As shown, the system is powered up in a normal mode operation with the normal mode regulator 142 supplying the nominal value, for example, at around 700 mV. When a command to enter the retention mode is received, the transition amplifier 220 is turned on at around 10 μS. After waiting for a fixed amount of time for the transition amplifier 220 to stabilize (2 μS in the example of FIG. 4), the normal mode regulator 142 is turned off at around 12 μS. At this point, the retention mode manager 200 is also taken out of the standby mode at around 12 μS. The supply voltage makes the smooth transition (while minimizing undershoot or overshoot) from the nominal value (e.g., around 700 mV) to the retention value (e.g., around 500 mV). The slope of the transition is determined by the RC time constant.

The system waits for a fixed amount of time (e.g., 10 μS [22 μS−12 μS] in the example of FIG. 4) for the supply voltage to make the transition from the nominal value to the retention value. The transition amplifier 220 is then turned off at around 22 μS. Although the turn off of the transition amplifier 220 causes a slight overshoot 410 in the retention voltage, the overshoot 410 is not large enough to cause any problem with the data retention. This keeps the system in the retention mode for an indeterminate amount of time until a command to exit the retention mode is received and the normal mode regulator 142 is turned back on at around 42 μS. This time, the supply voltage makes a smooth transition back to the nominal value at around 700 mV from the retention value at around 500 mV.

Although several embodiments of the invention are described above, many variations of the invention are possible. For example, although the illustrated embodiments describe directly transitioning from the nominal voltage to the retention voltage, other embodiments are possible. For example, the transition from the nominal voltage to the retention voltage can be made through an intermediate voltage also controlled by the transition amplifier. Further, features of the various embodiments may be combined in combinations that differ from those described above. Moreover, for clear and brief description, many descriptions of the systems and methods have been simplified. Many descriptions use terminology and structures of specific standards. However, the disclosed systems and methods are more broadly applicable.

Those of skill will appreciate that the various illustrative blocks and modules described in connection with the embodiments disclosed herein can be implemented in various forms. Some blocks and modules have been described above generally in terms of their functionality. How such functionality is implemented depends upon the design constraints imposed on an overall system. Skilled persons can implement the described functionality in varying ways for each particular application, but such implementation decisions should not be interpreted as causing a departure from the scope of the invention. In addition, the grouping of functions within a module, block, or step is for ease of description. Specific functions or steps can be moved from one module or block without departing from the invention.

The various illustrative logical blocks, units, steps, components, and modules described in connection with the embodiments disclosed herein can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration. Further, circuits implementing the embodiments and functional blocks and modules described herein can be realized using various transistor types, logic families, and design methodologies.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent presently preferred embodiments of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A retention mode manager circuit, comprising:
a resistor and a capacitor configured as an RC filter, and
the RC filter is configured to receive a retention voltage and output a filtered retention voltage;
a retention amplifier configured to receive the filtered retention voltage at a first input terminal and to provide current to a load corresponding to the filtered retention voltage; and
a transition amplifier configured to receive the filtered retention voltage and an offset voltage, and to guide the filtered retention voltage to make a transition to the offset voltage while minimizing undershoot or overshoot to prevent a loss of data in the load.

2. The circuit of claim 1, further comprising
a first transistor configured to supply current corresponding to the filtered retention voltage at the first input terminal of the retention amplifier which is configured to drive the first transistor.

3. The circuit of claim 2, wherein the current supplied by the first transistor is converted to a voltage and fed back to a second input terminal of the retention amplifier.

4. The circuit of claim 2, further comprising a second transistor coupled to the first transistor.

5. The circuit of claim 4, further comprising
a controller configured to generate signals including a standby signal to control the retention amplifier, the transition amplifier, and the second transistor.

6. The circuit of claim 5, wherein the standby signal is used to put the retention amplifier in a standby mode.

7. The circuit of claim 6, wherein the second transistor prevents the first transistor from supplying the current to the load when the retention amplifier is in the standby mode.

8. The circuit of claim 1, wherein the offset voltage received at the transition amplifier is set to a minimum voltage required to maintain consistency in the data in the load.

9. A method for transitioning a supply voltage from a nominal value to a retention value, the method comprising:
receiving a command from a controller to enter a retention mode;
programming a load by the controller to be in a static state that allows retention of data consistency in the load;
turning on a transition amplifier by the controller and waiting for the transition amplifier to stabilize;
turning off a normal mode regulator by the controller;
transitioning a retention mode regulator from a standby mode to the retention mode by the controller, and waiting for the supply voltage to transition from the nominal value to the retention value; and
turning the transition amplifier off by the controller.

10. The method of claim 9, further comprising
commanding by the controller to a retention amplifier to enter the retention mode to supply current corresponding to the retention value to the load.

11. The method of claim 10, further comprising
generating a standby signal by the controller to control the retention amplifier and the transition amplifier.

12. The method of claim 11, wherein the standby signal is used to put the retention amplifier in a standby mode.

13. The method of claim 10, further comprising:
receiving the supply voltage at an RC filter formed by a resistor and a capacitor,
wherein the supply voltage is at the retention value; and
filtering the supply voltage at the retention value by the RC filter to output a filtered retention voltage.

14. The method of claim 13, further comprising
guiding the filtered retention voltage by the transition amplifier to make a smooth transition to an offset voltage while minimizing undershoot or overshoot to prevent a loss of data in the load.

15. The method of claim 14, wherein the offset voltage is set to a minimum voltage required to maintain consistency in the data in the load.

16. An apparatus for transitioning a supply voltage from a nominal value to a retention value, the apparatus comprising:
first means for receiving and filtering a retention voltage and outputting a filtered retention voltage;
second means for receiving the filtered retention voltage and providing current to a load corresponding to the filtered retention voltage; and
third means for receiving the filtered retention voltage and an offset voltage and guiding the filtered retention voltage to make a smooth transition to the offset voltage without any undershoot or overshoot to prevent a loss of data in the load.

17. The apparatus of claim 16, further comprising
means for entering the retention mode to supply current corresponding to the retention value to the load.

18. The apparatus of claim 17, further comprising
means for generating a standby signal to control the second means and the third means.

19. The apparatus of claim 18, wherein the standby signal is used to put the second means in a standby mode.

20. The apparatus of claim 16, further comprising
means for filtering the supply voltage at a retention value to output a filtered retention voltage.
